(19) United States
(12) Patent Application Publication
(10) Pub. No.: US 2007/0125252 A1
(43) Pub. Date: Jun. 7, 2007

(54) Device and method for printing features onto a substrate

(75) Inventors: Jeffrey A. Chapman, Burgess Hill (GB); Arie R. Van Doorn, Zaltbommel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/576,317

(22) PCT Filed: Oct. 15, 2004
(86) PCT No.: PCT/IB04/52106

§ 371 Date: Apr. 18, 2006

(30) Foreign Application Priority Data
Oct. 22, 2003 (GB) 0324563.6

(51) Int. Cl. B41F 33/00

(52) U.S. Cl. 101/483

(57) ABSTRACT

Features (31, 51, 91) are printed onto a substrate (30, 50, 90) by providing a cliché (20, 40) having multiple narrow lines having a predefined spacing, filling the cliché with a printing medium and printing the lines onto the substrate, the spacing between the printed lines being such that the printing medium from adjacent lines coalesces to form the feature.

This application relates to a device and method for printing features onto substrates. In particular, this application relates to an improved method and apparatus for producing topographical features on substrates, for example substrates for use in Active Matrix Liquid Crystal Displays (AMLCDs).

In applications such as the fabrication of AMLCDs, significant cost savings are possible if the relatively costly photolithographic production steps used for applying layers to substrates are replaced by either high quality printing of resist onto the substrate prior to etching or by direct printing of precursors which may subsequently be treated or cured to give conducting, insulating or semiconducting layers.

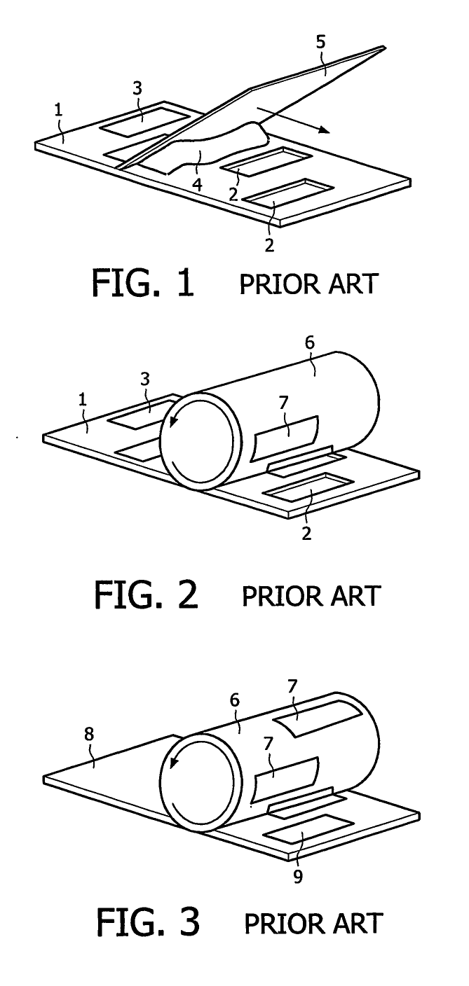

Offset lithographical techniques such as gravure offset printing use a cliché that is patterned with recessed portions or grooves, these corresponding to features required in a layer to be applied to a substrate. U.S. patent application publication US-A-2003/0081095 describes an example of the use of gravure offset printing in the fabrication of an LCD device. An illustration of the process of gravure offset printing is provided in FIGS. 1 to 3.

Referring firstly to FIG. 1, a cliché 1 having a series of generally rectangular recessed portions 2 in its upper surface is depicted. In a preliminary stage in the printing process, the recesses 2 are filled with a material 3 that is to be applied as a layer onto a substrate. The material 3 may be any of a number of functional materials, and is in this example a photoresist material. Surplus material 4 is removed from the cliché surface using a doctor blade 5 in a doctoring process, the blade being passed over the surface of the cliché 1 to remove material 4 that is not within a recess 2.

In a further stage, a blanket roller 6 is applied to the cliché 1, as depicted by FIG. 2. The blanket roller 6 is a cylindrical roller having a covering of a material such as silicone. The blanket roller 6 is rolled over the surface of the cliché 1 and some of the photoresist material 3 from the filled recesses 2 is thus transferred to the surface of the blanket roller 6. The transferred photoresist material forms portions 7 on the blanket roller surface, the position and shape of these corresponding to the position and shape of recesses 2 on the cliché 1.

In a final step depicted in FIG. 3 the blanket roller 6 is rolled over the surface of a substrate 8. Portions of photoresist material 7 that were transferred to the blanket roller 6 from the cliché 1 are now deposited onto the substrate 8 to form printed features 9 on the substrate surface.

One limitation to the process of offset printing is that it is difficult to print widely varying line-widths in a single print run. Each single print run is generally limited to having a unique ink formulation and cliché feature depth, the values of which influence the line widths that may be printed in that print run.

A problem associated with the printing of medium and large-width features onto substrates using offset printing techniques is that such features require deeper cliché recesses to define them than narrower features. This means that thicker clichés, are required which are more expensive to produce than thinner clichés, and that more ink is required in the printing process. Different ink formulations may also be optimal for features of different width.

A further drawback to offset printing is that pinholes are often formed in medium and large-width features printed using this technique. These are small holes in printed layers that have a detrimental effect on the performance of the layer, for example because the pinholes allow etching agents to reach the substrate through a resist layer. In applications such as the manufacture of AMLCDs, it is advantageous to minimise the formation of such pinholes in layers on substrates.

The present invention aims to address the above problems.

According to a first aspect of the invention there is provided a method of printing a feature onto a substrate comprising printing a plurality of spaced apart elements onto the substrate, each of the elements being smaller than the feature and the spacing between the elements being such that they combine on the substrate to form the feature.

The elements being smaller than the feature may comprise the elements being narrower than the feature.

Building a feature up from a plurality of narrower elements may have a number of advantages. First, a variety of different element widths may be printed at the same time, by combining different numbers of narrower elements into wider features. Second, the use of narrower elements has been found to reduce the likelihood of the formation of pinholes. Third, the use of thinner clichés is enabled since only relatively narrow features need to be printed, in turn needing less material to make the cliché and less element material to obtain the coverage required.

The elements may comprise a printing medium such as ink, which may combine by coalescing. The ink elements spread out when printed to achieve coverage over any predefined feature size.

Printing elements that are of equal size, for example a plurality of narrow fine lines, may allow a single pass to define each level of a pattern, since a unique formulation of ink and cliché depth may be used for printing all of the elements.

According to a second aspect of the invention there is provided an apparatus for printing a feature onto a substrate, the apparatus comprising means for printing a plurality of spaced apart elements onto the substrate, each of the elements being smaller than the feature and the spacing between the elements being such that the elements combine on the substrate to form the feature.

The printing means may comprise a plurality of portions each of the portions corresponding to one of the elements, and the portions may be of equal size.

For a better understanding of the invention, embodiments thereof will now be described, purely by way of example, with reference to the accompanying drawings, in which:

FIG. 1 is an illustration of a step in the process of gravure offset printing involving applying material to a cliché;

FIG. 2 is an illustration of a step in the process of gravure offset printing involving transferring material from a cliché to a blanket roller;

FIG. 3 is an illustration of a step in the process of gravure offset printing involving transferring material to be printed from a blanket roller to a substrate;

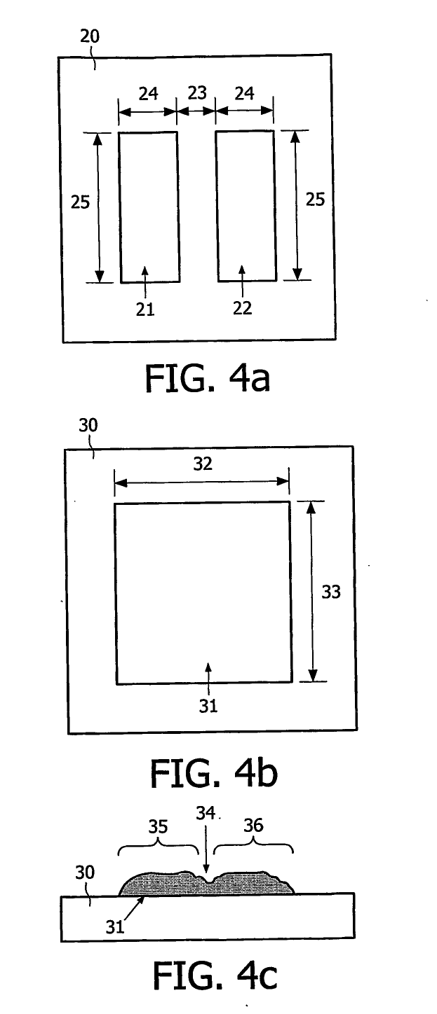

FIG. 4a is a plan view of a first cliché, for use in a printing process according to the invention;

FIG. 4b is a plan view of a substrate having a feature that has been printed using the first cliché;

FIG. 4c is a cross-sectional view of a substrate that has been printed using the first cliché;

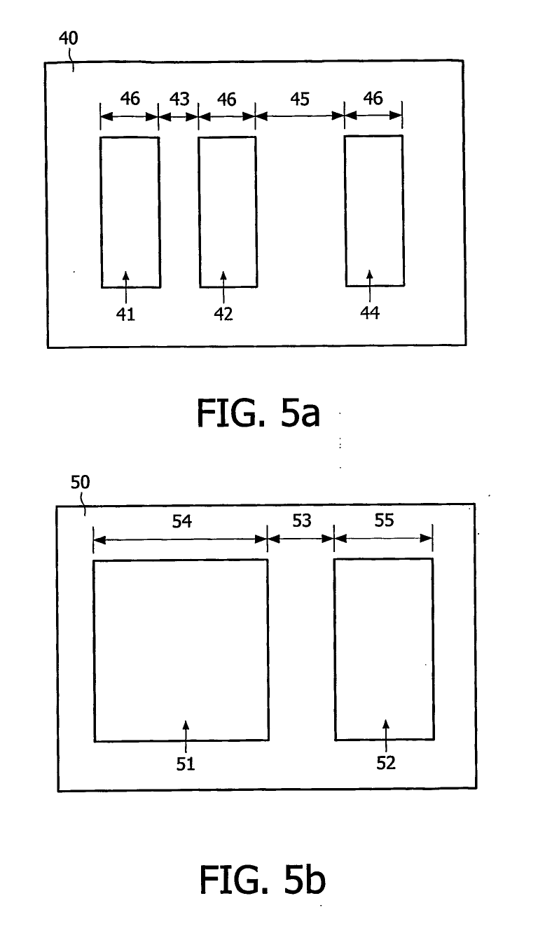

FIG. 5a is a plan view of a second cliché according to the invention;

FIG. 5b is a plan view of a substrate having features that have been printed using the second cliché;

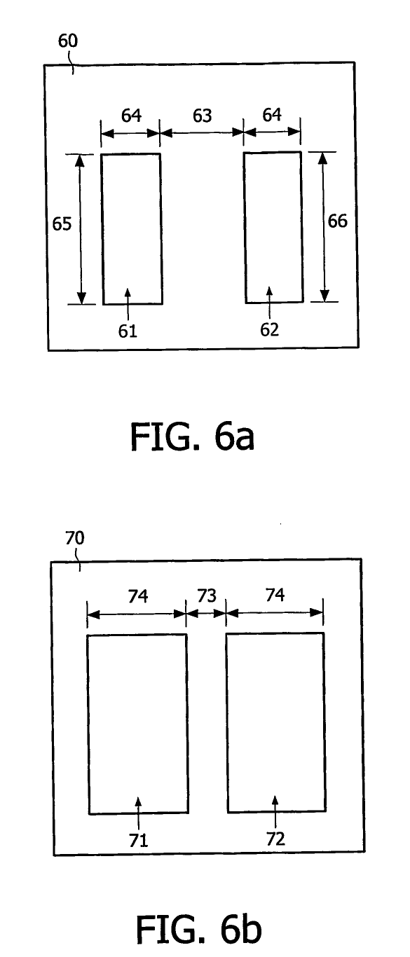

FIG. 6a is a plan view of a third cliché for use in determining element spacing for features according to the invention;

FIG. 6b is a plan view of a substrate having features that have been printed using the third cliché;

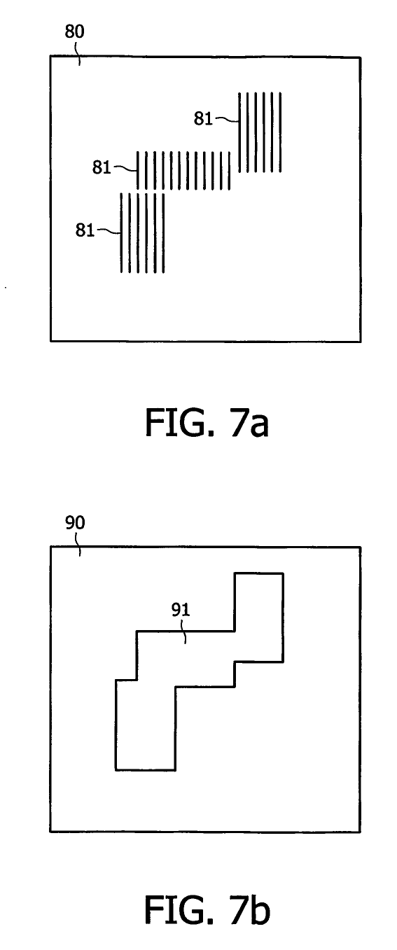

FIG. 7a is a plan view of a fourth cliché according to the invention; and

FIG. 7b is a plan view of a substrate having a feature printed using the fourth cliché.

Referring to FIG. 4a, a plan view of a first cliché 20 according to the invention is illustrated. The first cliché 20 comprises first and second rectangular recesses 21, 22 separated by a gap 23 of 4 μm. The recesses 21, 22 may be formed using a conventional technique such as photolithography. The rectangular recesses 21, 22 have widths 24 of 10.5 μm, lengths 25 of 40 μm, and depths of between 5 and 15 μm, for example 10 μm. The first cliché 20 is fabricated by depositing a polyimide material on a glass layer and has an overall thickness of, for example, 1 mm.

The cliché 20 is filled with a suitable ink by using, for example, a doctor blade. The ink is, for example, an etch resist ink comprising 40 wt % Jonacryl ECO684 and 60 wt % Butyl Glycol Acetate/Tributyrin (in a ratio of 70/30 w/w). The cliché 20 is then used in a printing process such as gravure offset printing to print a layer onto a substrate 30. A plan view of the resulting substrate 30, in this case a glass or flexible substrate for use in an AMLCD, having a layer of etch resist material 31, is illustrated in FIG. 4b, and is formed having a single continuous rectangular feature 31.

The single continuous feature 31 forms because the recesses 21, 22 defined in the cliché surface result in features on the substrate 30 that spread out when printed from the cliché 20 to the substrate 30. Since, in this example, the spread of the printed features is 2.5 μm in each direction across the substrate 30, printed features on the substrate are greater than their corresponding cliché recess in length and width by 5 μm. Accordingly, the gap 23 of 4 μm between the rectangular recesses 21, 22 on the first cliché 20 is bridged by the resist material and a single feature 31 is therefore printed onto the substrate 30. The single feature 31 is thus a result of the material from corresponding recesses 21, 22 of the first cliché 20 coalescing and is thus 30 μm in width 32 (15.5 μm plus 15.5 μm with an overlap of 1 μm) and has a length 33 of 45 μm.

The gap 23 between the rectangular recesses 21, 22 is chosen in this example to be 4 μm. This allows an overlap of 1 μm of the corresponding features printed onto the substrate to ensure that the coalesced feature 31 is continuous. The gap 23 is therefore dependent on the amount of spread of elements 21, 22 when transferred from the cliché 20 to the substrate 30, which will in turn depend on the ink formulation, the nature of the substrate, the printing technique used and so on.

FIG. 4c illustrates a cross-sectional view of the substrate 30 having the layer of resist material 31 printed using the first cliché 20. It can be seen that the resist material 31 is formed in first and second portions 35, 36 defined by a shallow trough 34 between them. This trough 34 is caused by the thinning of the edges of the first and second portions 35, 36 which correspond to the first and second recesses 21, 22 of the first cliché 20 respectively.

Although the material layer 31 is generally thinner at the shallow trough 34, there is at least some coverage over the entire area, which is more important in certain applications, for example in the printing of resist, than the fact that the layer 31 is not uniformly thick.

The recesses 21, 22 on the surface of the cliché 20 are chosen to be of a width that substantially avoids the formation of pinholes. Experimentation has shown that the recess width 24 should be kept below approximately 30 μm to reduce the likelihood of pinholes forming, although this may depend on other factors in the printing process.

The narrow recesses 21, 22 may also be formed on clichés 20 that are relatively shallow, for instance having a depth of the order of 5 μm. Having shallow clichés reduces materials cost in cliché production.

The invention is not limited to the gravure offset printing process described. Many other printing techniques may also be used to print coalescing features according to the invention, including for example waterless offset and microcontact printing.

FIG. 5a illustrates a plan view of a second cliché 40 according to the invention, which will be used to illustrate the principle of forming features having different widths in a single print run. This cliché 40 comprises first and second aligned rectangular recesses 41, 42 separated by a gap 43 of 4 μm, and a third aligned rectangular recess 44 positioned a predetermined distance 45 of 8 μm from the second recess 42. The recesses 41, 42, 44 are each of an equal width 46 of 10.5 μm and are formed in a similar manner to those 21, 22 of the first cliché 20.

The second cliché 40 is used in a printing process such as gravure offset printing to print a layer onto a substrate 50. A plan view of the resulting substrate 50, in this case a glass substrate for use in an AMLCD, having a resist layer, is illustrated in FIG. 5b, and is formed having first and second rectangular features 51, 52. The first feature 51 is formed by a coalescence of material printed from the first and second recesses 41, 42 of the cliché 40, in a similar manner to the feature 31 printed from a coalescence of the first and second recesses 21, 22 of the first cliché 20. The second narrower rectangular feature 52 is positioned at a distance 53 of 3 μm from the first feature 51 and has not coalesced with other features on the substrate 50.

The two printed features 51, 52 have widely varying widths 54, 55 of 30 μm and 15.5 μm respectively, but are produced using a cliché 40 having recesses 41, 42, 44 of equal width. Features 51, 52 having widely varying line widths may therefore be printed in a single print run, since a unique ink formulation and cliché feature depth may be used. Each unique ink formulation and cliché feature depth may be used with a restricted range of feature widths, which enables different sized features above the minimum width to be constructed for a single print level via a combination of feature widths within the range. The clichés 20, 40 according to the invention may therefore overcome the limitations that are associated with offset lithography. Forming narrow recesses on clichés that define features that coalesce when transferred to a substrate reduces the likelihood of formation of pinholes, enables the use of thinner clichés, and reduces the number of print runs required.

The amount of spread of the material when applied to the substrate is likely to be dependent on multiple factors, including the depth of features on the cliché, the viscosity of the material used, the speed of printing as well as any post-printing processes, such as the use of a roller over the top of printed features, before they set, to flatten domed features. Using these parameters to calculate the required gap 23, 43 between recesses on a substrate that will enable the corresponding printed features to coalesce is therefore complex. A method for calculating this gap will now be described with reference to FIGS. 6a and 6b.

FIG. 6a illustrates a plan view of a third cliché 60. This cliché 60 comprises first and second aligned rectangular recesses 61, 62 separated by a gap 63 of 10 μm. This gap 63 is chosen to be an arbitrary width that is large enough such that the printed features corresponding to the recesses 61, 62 are unlikely to coalesce when printed. The recesses 61, 62 are each of an equal width 64 of 12 μm and are formed in a similar manner to those 21, 22 of the first cliché 20.

The third cliché 60 is used in a desired printing process to print a layer onto a substrate 70. A plan view of the resulting substrate 70, is illustrated in FIG. 6b, and is formed having first and second aligned rectangular features 71, 72. The width 73 between the first and second aligned features 71, 72 is measured and compared to the-gap 63 between the rectangular recesses 61, 62 on the third cliché 60. In the example depicted in FIG. 6b, the first and second features 71, 72 on the substrate 70 are separated by a gap 73 of 5 μm. The difference between the gap 63 of 10 μm between the recesses 61, 62 on the third cliché 60 and this gap 73 of 5 μm is thus 5 μm. This signifies that each feature 71, 72 has spread by 2.5 μm towards the other. In order to enable features to coalesce when printed, their corresponding recesses 61, 62 on the printing cliché should therefore be a maximum of 5 μm apart, and a gap of, for example, 4 μm will thus ensure complete coverage of the substrate at the join of the features, for instance as illustrated in FIG. 4c.

From reading the present disclosure, other variations and modifications will be apparent to persons skilled in the art. Such variations and modifications may involve equivalent and other features which are already known in the design, manufacture and use of printed substrates and which may be used instead of or in addition to features already described herein.

In particular, the invention is not limited to clichés comprising two recesses for printing elements that coalesce to form a single feature. A plurality of recesses may be formed on a cliché, the recesses being spaced such that their resulting printed elements coalesce to form a single printed feature. For instance, a plurality of parallel fine lines may be printed which coalesce to form a relatively large area of continuous material. FIGS. 7a and 7b illustrate how multiple fine lines 81 printed from a cliché 80 according to the invention, coalesce on a substrate 90 to form a single feature 91.

Furthermore, the recesses need not be rectangular as depicted in the figures. Any shape of recess may be used, and equally the resulting coalesced features need not be rectangular. The shape and position of recesses and hence of resulting features may be dependent on other layers or components on the substrate.

A plurality of fine lines may be printed which coalesce to form a relatively large area of continuous material with openings in pre-defined positions, defining contact holes.

The invention is not limited to the fabrication of AMLCDs. It may also be applied to any other printed layers on substrates. The choice of printed material, cliché material and substrate material would be influenced by the particular application. The printed material is not limited to resist, but could for example be a metal precursor, such as an ITO precursor, which is subsequently cured to form a metal layer.

Although offset printing techniques have primarily been described in this application, the invention is applicable to other printing techniques. Certain techniques may involve the use of clichés which, rather than having recessed portions to define features to be printed, have raised or protruding portions to which material to be printed is applied.

Although claims have been formulated in this application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of printing a feature (31, 51, 91) onto a substrate (30, 50, 90) comprising:
printing a plurality of spaced apart elements (35, 36) onto the substrate, each of the elements being smaller than the feature and the spacing (23, 43) between the elements being such that they combine on the substrate to form the feature.

2. A method according to claim 1, wherein the elements comprise a printing medium and combine by coalescing.

3. A method according to claim 1, further comprising:
printing the elements onto the substrate (30, 50) using a printing means, wherein the printing means comprises a plurality of portions (21, 22, 41, 42), each of the portions corresponding to one of the elements.

4. A method according to claim 3, wherein the portions (21, 22, 41, 42) comprise recesses in a surface of the printing means.

5. A method according to claim 3, further comprising:
applying a printing medium to the portions (21, 22, 41, 42); and
transferring the printing medium to the substrate (30, 50).

6. A method according to claim 5, wherein the printing medium is transferred to the substrate (30, 50) via an intermediate device.

7. A method according to claim 3, wherein the portions (21, 22, 41, 42) are of equal or substantially similar size.

8. A method according to any one of claim 3, wherein the portions (21, 22, 41, 42) are parallel.

9. A method according to claim 3, wherein the printing means comprises a cliché (20, 40).

10. A method according to claim 2, wherein the printing medium comprises a resist material (31).

11. A method according to claim 1, wherein each of the elements is narrower than the feature.

12. A method according to claim 1, wherein each of the elements is shorter than the feature.

13. A method according to claim 1, comprising printing a plurality of elements which coalesce to form a continuous feature having openings in pre-defined positions.

14. Apparatus for printing a feature (31, 51) onto a substrate (30, 50), comprising means for printing a plurality of spaced apart elements onto the substrate, each of the elements being smaller than the feature and the spacing between the elements being such that the elements combine on the substrate to form the feature.

15. Apparatus according to claim 14, wherein the printing means comprises a plurality of portions (21, 22, 41, 42), each of the portions corresponding to one of the elements.

16. Apparatus according to claim 15, wherein the portions (21, 22, 41, 42) comprise recesses in a surface of the printing means.

17. Apparatus according to claim 15, wherein the portions (21, 22, 41, 42) are of equal or substantially similar size.

18. Apparatus according to claim 15, wherein the portions (21, 22, 41, 42) are parallel.

19. Apparatus according to claim 14, wherein the printing means comprises a cliché (20, 40).
